(19) United States
(12) Patent Application Publication
(10) Pub. No.: US 2011/0285820 A1
(43) Pub. Date: Nov. 24, 2011

(54) USING 3D TECHNOLOGY TO PROVIDE SECURE DATA VIEWING ON A DISPLAY

(76) Inventors: Martin C. Bittner, Redwood City, CA (US); Teresa L. Bittner, Redwood City, CA (US)

(21) Appl. No.: 13/109,329

(22) Filed: May 17, 2011

Related U.S. Application Data
(60) Provisional application No. 61/345,832, filed on May 18, 2010.

(51) Int. Cl. H04N 13/02

(52) U.S. Cl. 348/46; 348/E13.074

(57) ABSTRACT

A method and system using 3D technology provides secure data viewing on a display. Secure data viewing is enable by having an image source module provide images to a processor module. The processor module receives the images provided by the image source module to create multiple series of images that interfere with each other resulting in an unreadable series of images displayed on a display module. An authorized viewer is able to view a readable series of images from the multiple interfering series of images displayed by the display module.

### CROSS-REFERENCE TO RELATED APPLICATIONS

This invention claims priority, under 35 U.S.C. §120, to the U.S. Provisional Patent Application No. 61/345,832 to Martin Bittner filed on May 18, 2010, which is incorporated by reference herein.

### BACKGROUND

Three dimensional (3D) technology is finally entering the consumer market with the introduction of 3D TV's to provide an enhanced experience for the consumer and improved 3D techniques for cinema. Each technique presents a pair of images that are displaced by some distance when viewed along the two different sight lines viewed by each eye which is referred to as parallax. The brain processes the shifted images to reconstruct a three dimensional scene.

These 3D technologies are now being incorporated into many types of media, for example: a) video games, b) media for 3D TV's, and c) movies for the cinema. Many video games have the ability to partition the display into separate areas, one for each player, for multi-player games. Each player then watches the area assigned to their view to play the game. A problem arises when a player looks at another player's area to help them gain an advantage. A technique to prevent this would enhance the experience of all players who use a single display when playing multi-player games.

Other advantages could be gained by a technique to display multiple series of images on a single display and allowing viewers to select the series of images they want to view. One possibility is to allow multiple viewers to simultaneously view different programs on a TV. Another would be to impose parent control on a program by allowing parents to view an “unedited” version while limiting younger viewers to view a “edited” version of the same program. A third possibility is to allow viewers to watch a program from different points of view—from different characters point of views. This last possibility would be a boon to movies shown in cinemas since people could watch a movie multiple times, each time from a different character's point of view. Up until now there has been no method or system to allow independent and simultaneous viewing of multiple series of images by multiple groups of viewers.

Another problem relates to privacy of data when displayed on a monitor. For example, in a hospital any confidential information displayed on a screen should only be viewed by authorized personnel. Today monitors used in hospitals allow anyone walking by a monitor to view the information displayed.

What is needed is a system and method that solves one or more of the problems described herein and/or one or more problems that may come to the attention of one skilled in the art upon becoming familiar with this specification.

### SUMMARY

A system using 3D technology to prevent unauthorized persons from viewing confidential information, the system comprising:
a. an image source module to provide images;
b. the processor module connected to the image source module to receive the images provided by the image source module to create multiple series of images that interfere with each other;
c. a display module connected to the processor module to display the multiple series of images that interfere with each other resulting in an unreadable image on the display; and,
d. an authorized viewer able to view a readable series of images from the multiple interfering series of images displayed by the display module.
   The system wherein the display implements temporal separation to display multiple series of images, and a viewer uses eyewear to restrict viewing to the single series of images from the multiple series of images displayed. The system wherein the display implements spatial separation to display multiple series of images, and a lateral position of the viewer restricts viewing to the single the series of images from the multiple series of images displayed.

A method whereby 3D technology is used to prevent unauthorized persons from viewing confidential information, the method comprising the steps of:
a. providing images from an image source module;
b. processing the images from the image source module to create multiple series of images that interfere with each other resulting in an unreadable series of images;
c. displaying the multiple series of images that interfere with each other resulting in an unreadable image on a display module; and,
d. enabling an authorized viewer to view a readable series of images from the unreadable images displayed by the display module.
   The method wherein the step of displaying is implemented using temporal separation to display multiple series of images, and the step of restricting a viewer to a single series of images from the multiple series of images is implemented by the viewer wearing eyewear. The method wherein the step of displaying is implemented using spatial separation to display multiple series of images, and the step of restricting the viewer a single series of images is implemented by the lateral position of the viewer.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as series forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a diagram showing temporal separation of a series of images from a single display as implemented by a 3D technology having alternating series of images wherein one series of images is intended for the right eye and a second series of images are intended for the left eye.

FIG. 2 is a diagram using the 3D technology of FIG. 1, but the alternating series of images from a single display are viewed by different viewers instead of being intended for a single person's right and left eye according to one embodiment of the invention.

FIG. 3 is a diagram showing spatial separation of two series of images from a single display implemented by several 3D technologies wherein one series of images is viewed by the right eye and a second series of images being viewed by the left eye.

FIG. 4 is a diagram using the 3D technology of FIG. 3, but having the images from a single display further separated such that two independent viewers view a different series of images according to one embodiment of the invention.

FIG. 5 shows a block diagram of a 3D system using 3D technology to display multiple series of images for viewing by multiple independent groups of viewers according to one embodiment of the invention.

### DESCRIPTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Any of the functions, features, benefits, structures, and etc. described herein may be embodied in one or more modules. Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data series, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: compressed data in all forms; and/or like data useful in the operation of the present invention. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

3D technologies include a broad array of methods and systems, comprising:

1) Temporal Separation (Time Multiplexed)—requires eyewear
a. Alternate Sequencing
b. Polarization
c. Wavelength Shifted, Interference Filter
d. Anaglyphic

2) Spatial Separation (Autostereoscopic)—no eyewear required
a. Lenticular—array of cylindrical lenses
b. Parallax Barrier—array of parallel slits
c. Integral Imaging—array of spherical lenses
d. Light Steering—steering image to appropriate eye
   Each technique presents a pair of images, or pairs of series of images, that are displaced by some distance when viewed along the two different sight lines viewed by each eye. The brain processes the shifted images to reconstruct a three dimensional scene.

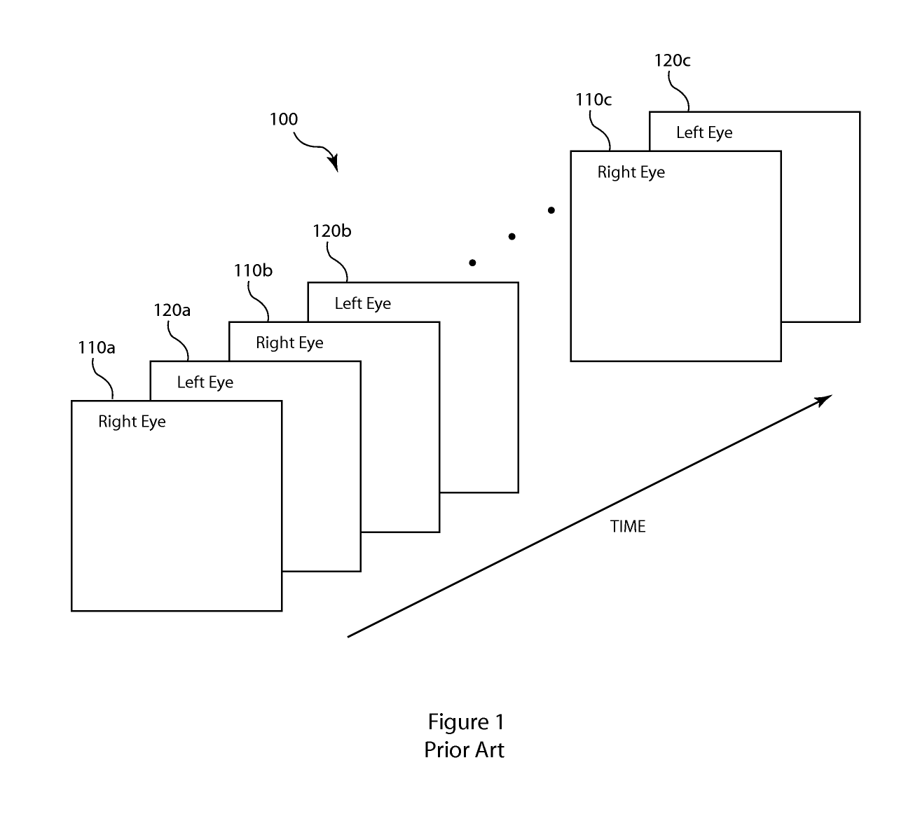

FIG. 1 is a diagram showing temporal separation of a series of images from a single display as implemented by a 3D technology having alternating series of images wherein one series of images is intended for the right eye and a second series of images are intended for the left eye. In the simplest form a first series of images 110 are displayed for the right eye and a second series of images 120 are displayed for the left eye. Eyewear is then used to occlude one series of images from one eye at a time. For example, when the series of images for the right eye are displayed the eyewear occludes the left eye from seeing this series of images. When the series of images intended for the left eye are displayed then the eyewear occludes the right eye from seeing these images. Although FIG. 1 shows alternating images for each eye, multiple images for a given eye may be sequentially displayed before a second series of sequential images is displayed for the second eye. Also, for polarization, wavelength shifted, and anaglyphic images pairs of images may be simultaneously displayed since the eyewear selectively passes the appropriate image to each eye.

Several types of eyewear are used in temporally separated 3D systems depending on the 3D technique used to display the images. Examples of eyewear are:
1. Active Shutter lenses
2. Polarized lenses
3. Wavelength Shifted lenses
   Active shutter lens eyewear is used when series of images for each eye are sequentially alternated. One eye at a time is occluded from viewing a displayed image with the frame rate high enough to prevent flickering of the series of images. The result is each eye views an image that is spatially shifted from the image viewed by the other eye allowing the brain to process a pair of images so the viewer perceives a 3D image. The eyewear wirelessly connects to a processor module to receive a synchronizing signal. Each lens is synchronized to the series of images so that only one eye at a time sees a single image or frame.

There are several technologies used in active shutter eyewear and they include
a. pi-cell LCD
b. twisted nematic—TN LCD
c. super twisted nematic—STN LCD:

Pi-cell LCD technology is generally used in applications where very fast switching cycle times are required. Pi cells also have an increased viewing angle, which is the result of the self-compensating nature of the cell structure. Pi cells have applications in 3D viewing, large screen TV's and high speed optical shutters. The name comes from the fact that a pi cell has a 180 degree twist, instead of a 90 degree twist like a normal TN cell. Typical Pi-cell active shutter eyewear lens' are capable of switching on and off at a 120 Hz rate providing flicker free viewing.

Polarized eyewear has orthogonal polarizations for each lens, such as one lens being right circularly polarized and the other lens being left circularly polarized. Polarized systems are used in cinemas using a special screen to project the images on so that the polarization is maintained. Each eye only sees the appropriate polarization while the image having the opposite polarization is filtered out. It is possible to project both polarized states simultaneously since each lens passively filters out the unwanted polarization.

A third technique uses wavelength shifted series of images. A dichroic filter wheel is used to wavelength shift images intended for the one eye from the wavelengths of the images intended for the other eye. In this system a series of images are transmitted as parallel image information in different triplets of primary colors. Both pairs of wavelength triplets are narrowband and are found within the red, blue, and green primary color bands. Each lens of the eyewear has a different dichroic lens that filter out the appropriate triplet of wavelengths making up the image intended for each eye. In this system it is also possible to simultaneously project images for both eyes simultaneously. In monochrome applications one wavelength pair may be used to display a series of images.

One of the oldest 3D techniques uses anaglyphic eyewear to separate a pair of images. Many different complementary colored lens pairs may be used, but most people are familiar with the red/blue lens pairs used in movie theaters. There is a new 3D technique used in TVs that uses lasers to project the 3D series of images and anaglyphic eyewear to filter out the appropriate image for each eye.

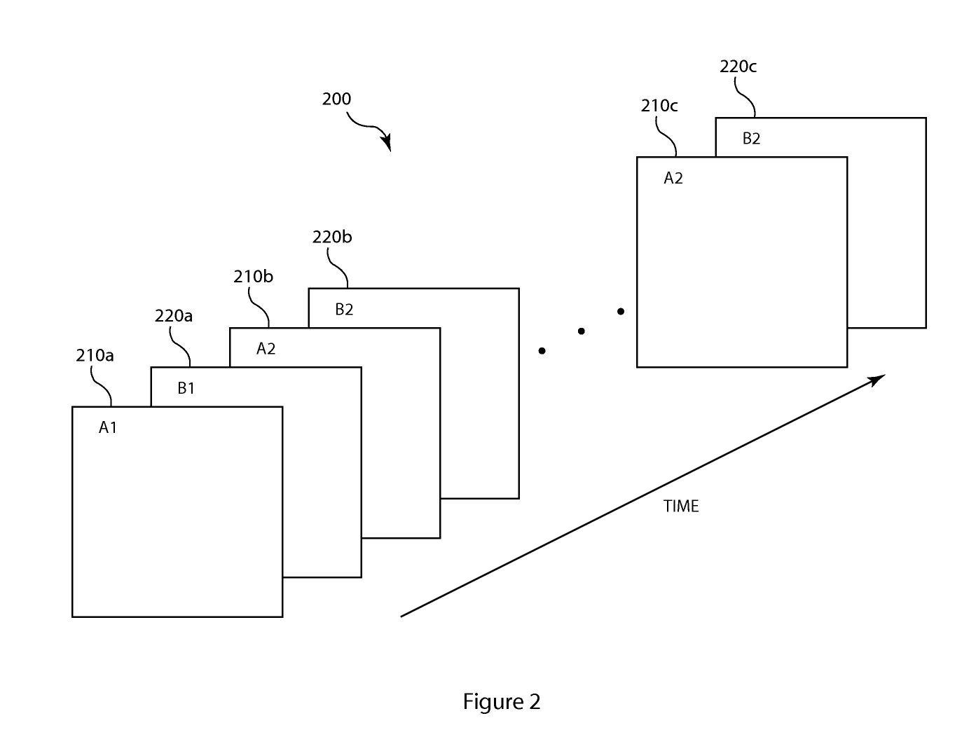

FIG. 2 is a diagram using the 3D technology of FIG. 1, but the alternating series of images from a single display are viewed by different viewers instead of being intended for a single person's right and left eye according to one embodiment of the invention. Two viewers, viewer A 210 and viewer B 220, are depicted in FIG. 2. Each viewer sees an independent alternating series of images. Unlike the system of FIG. 1 wherein each lens of the eyewear alternates states, on/off for shutter eyewear, orthogonal polarization states, dichroic lens selecting different sets of wavelengths, or anaglyphic eyewear having complementary colors, the eyewear of the present embodiment shown in FIG. 2 has the same type or state of lens for both eyes. To view a different series of images the viewer uses eyewear having the appropriate characteristics matching the state of the series of images to be viewed. For example, in the case of alternating series of images using active shutter eyewear to view the images, both lens' of the eyewear synchronized to simultaneously allow transmission of the alternating series of images to be viewed and change state to restrict viewing of all other series of images being displayed. For both polarization and dichroic eyewear the viewer selects the eyewear that allows simultaneous transmission of the series of images to be viewed.

Unlike 3D applications, in the embodiment shown in FIG. 2 more than two viewers can view different series of images. The limit on the number of multiple series of images being viewed using shutter technology is dependent on the frame rate of images displayed and on the rate shutter technology can change states. Both polarization and dichroic lenses are passive so only the frame rate of the display limits the number of multiple series of images that can be viewed. Unlimited numbers of viewers may view any one series of images, they just need to wear the appropriate eyewear.

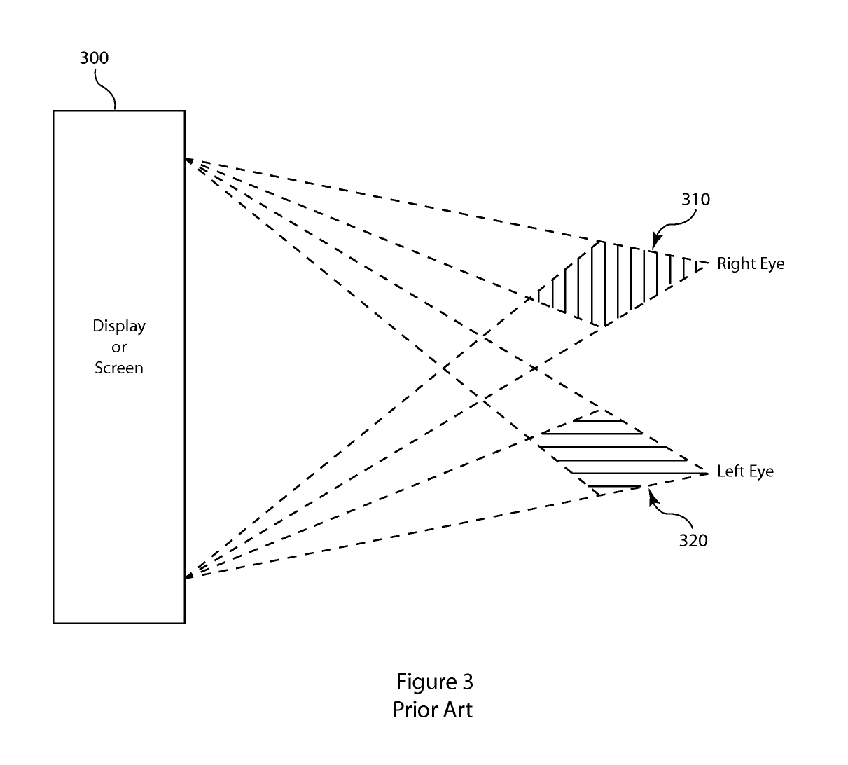

FIG. 3 is a diagram showing spatial separation of two series of images from a single display implemented by several 3D technologies wherein one series of images is viewed by the right eye and a second series of images being viewed by the left eye. Techniques vary but all require the viewer to view the display from a position wherein the right eye viewing area 310 and the left eye viewing area 320 are limited. Series of images are processed so that stereo pairs are simultaneously displayed and positioned on the display in such a manner that results in the image pairs being spatially separated.

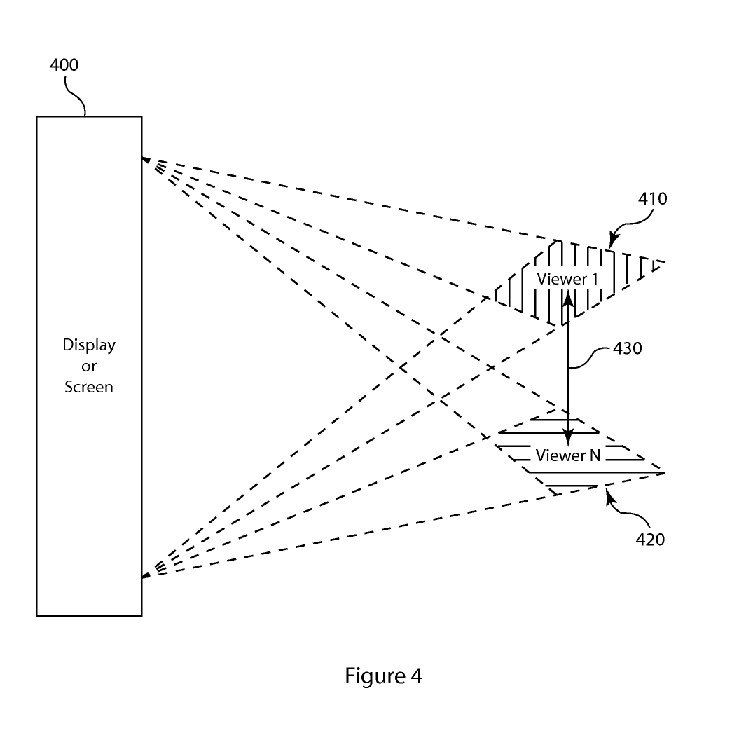

FIG. 4 is a diagram using the 3D technology of FIG. 3, but having the images from a single display separated such that two independent viewers view a different series of images according to one embodiment of the invention. In this application of spatially separated images the viewing areas, viewer 1 area 410 and viewer N area 420, are separated by a distance 430 such that each viewer only views the series of images they want to see.

Spatially separated 3D techniques will have predetermined number of positions that viewers can see any one series of images. Because each viewing position is limited in area these systems accommodate a limited number of viewers at any one time.

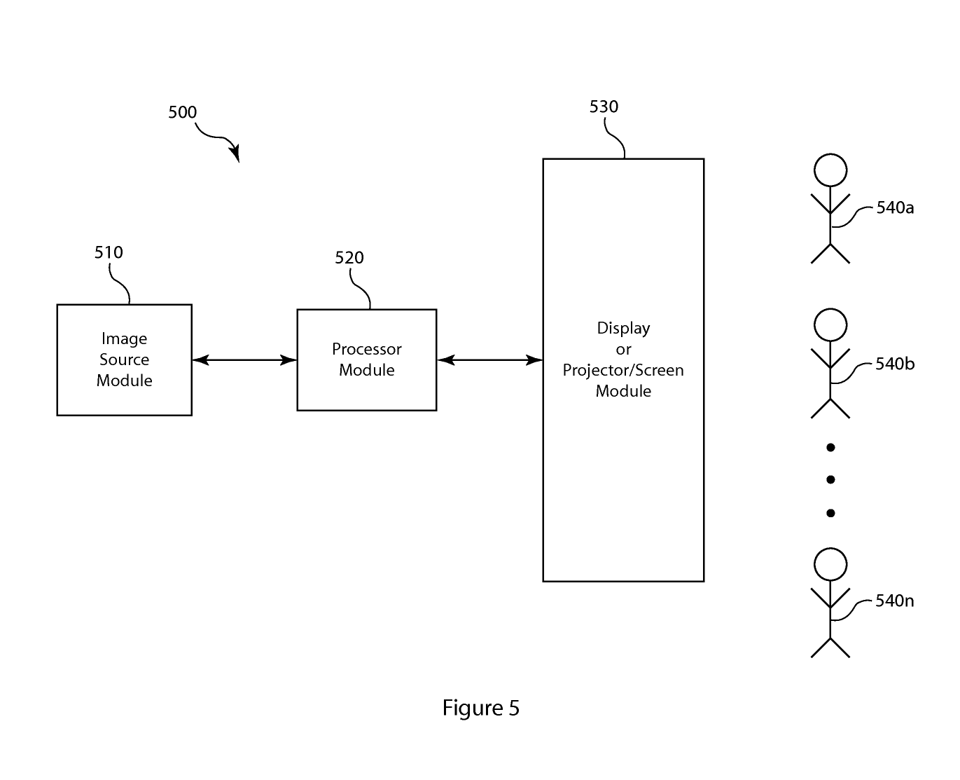

FIG. 5 shows a block diagram of a 3D system using 3D technology to display multiple series of images for viewing by multiple independent groups of viewers according to one embodiment of the invention.

Systems and methods such as depicted in FIG. 5 that are implemented using 3D technology require that several modules be modified. An image source module 510 is required to provide multiple series of images. In 3D technology this source generates two series of images, one for the right eye and a second series for the left eye. In the present invention multiple series of images may be provided for viewing by independent groups of viewers from a single display. These multiple series of images may be comprised of:
1. multiple views for a multi-player video game;
2. multiple TV shows;
3. multiple viewpoints from different characters in a movie or TV show;
4. edited and unedited series of images;
5. multiple series of photographs;
6. hybrid combinations of any of the above types of series of images;
7. multiple series of images that interfere with each other for secure viewing of a display, or a series of images that are restricted to viewing from a limited location; or,
8. any other type of multiple series of images.
   Examples of image source modules 510 include game consoles, DVD players, BluRay players, flash memory sticks, TV tuners, internet connected image sources, digital projectors in movie theaters, or any other type of image source.

Connected to the image source module 510 is a processor module 520 where images from the image source module 510 are processed into multiple series of images of an appropriate format for display. Processing requirements are dependent on the method of display—temporal or spatial separated series of images.

Temporally separated series of images require proper sequencing of images by the processing module 520 for display. The processing module 520 or display module 530 then applies any necessary additional processing to the images such as adding polarization or wavelength shifting to a series of images. Additional processing includes creating synchronization signals for each of the viewer's eyewear. Eyewear for each viewer 540 is then synchronized to restrict viewing to a single series of images from the multiple series of images displayed.

Spatially separated series of images require processing to properly displace images or micro-images dependent on the technique used. No modifications of the display or projector/screen module 530 are required.

It is possible to create hybrid systems that use two or more of the 3D techniques to implement a system that allows the display of multiple series of images for viewing by independent groups of viewers.

The following are nonlimiting examples of display and/or projector screen modules: a 3D projection display as described in U.S. Pat. No. 5,703,717, issued to Ezra et al. is incorporated for its supporting teachings; a display video apparatus as described in U.S. Pat. No. 5,132,839, issued to Travis is also incorporated for its supporting teachings herein; a DLP XGA proj 3000 Lum 3000 3D Projector, manufactured by Texas Instruments Inc., 12500 TI Blvd., Dallas, Tex., 75243; a Samsung 3D Television, manufactured by Samsung Electronics America, 105 Challenger Road, Ridgefield Park, N.J., 07660.

The following are nonlimiting examples of processor modules: a HP MediaSmart Server EX495, manufactured by Hewlett-Packard Company, 3000 Hanover Street, Palo Alto, Calif., 94304, USA; a Intel Server System SR2500ALBKPR, manufactured by Intel Corporation, 2200 Mission College Blvd, Santa Clara, Calif., 95054; a processor module as described in U.S. Pat. No. 4,443,865, issued to Schultz et al. is incorporated for its supporting teachings herein; a blade server module as described in U.S. Pat. No. 6,665,179, issued to Chou is incorporated for its supporting teachings herein. In a non-limiting example, a processor module includes hardware and/or software including instructions for coordinating the display of image information from a plurality of image sets through a display/projection system having the capacity to display according to a plurality of characteristics. The processor module may couple instructional metadata to image set data such that the display/projection module may receive and display the image data according to the accompanying instructions. Image processing may occur (in the processor module, display/projection module, other module, and/or combinations thereof), such as but not limited to color shifting, time shifting, cloning, scrambling, encrypting, polarizing, frequency mapping, and the like.

The following are nonlimiting examples of image/video processing modules: a 3D graphics accelerator described in U.S. Pat. No. 6,016,151, issued to Lin is incorporated for its supporting teachings herein; a 3D computer graphics system as described in U.S. Pat. No. 6,747,642, issued to Uasumoto, is incorporated for its supporting teachings herein; a 3D processing unit as described in U.S. Pat. No. 6,424,348, issued to Parikh et al., is incorporated for its supporting teachings herein; a 3D graphics model as described in U.S. Pat. No. 6,714,201, issued to Grinstein et al. is incorporated for its supporting teachings herein.

As a non-limiting example, a standard 2-D image feed of a football game may be received through a standard TV tuner. The image feed may be processed using techniques of image identification of familiar/known aspects of the images (game field lines/colors, player shapes, uniform color schemes) such that a parallax image may be generated to simulate a 3-dimensional view. The standard view and the parallax view may then be each cloned and time shifted thereby generating a second 3-D replay image feed to be communicated to a projection system for users wearing characteristic toggle-able 3-D capable eyewear. Accordingly, a standard 2-D feed may be used to create a simulated 3-D video display with an instant replay capability that is independently viewable and controllable per viewer.

The following are nonlimiting examples of image source modules: a content player described in U.S. Publication No.: 20100046917, by Naranjo, is incorporated for its supporting teachings herein; a integrated circuit as described in U.S. Publication No.: 20080100631, by Grearson et al., is incorporated for its supporting teachings herein; a channel service described in U.S. Publication No.: 20090316776, by Baek, is incorporated for its supporting teachings herein; a information reproducing apparatus described in U.S. Publication No.: 20090279400, by Sawabe, is incorporated for its supporting teachings herein; a video database as described in U.S. Pat. No. 5,485,611, issued to Astle, is incorporated for its supporting teachings herein; a video database as described in U.S. Pat. No. 6,631,522, issued to Erdelyi, is incorporated for its supporting teachings herein.

The following are nonlimiting examples of 3-D enabled eyewear: a 3D LCS glasses as described in U.S. Pat. No. 6,278,501, issued to Lin, is incorporated for its supporting teachings herein; a pair of 3D glasses as described in U.S. Pat. No. 6,115,177, issued to Vossler, is incorporated for its supporting teachings herein; a pair of Samsung SSG2100AB 3D glasses, manufactured by Samsung Electronics America, 105 Challenger Road, Ridgefield Park, N.J., 07660; a Nvidia GeForce 3D Vision Kit and glasses, manufactured by Nvidia Corporation, 2701 San Tomas Expressway, Santa Clara, Calif., 95050.

### Video Gaming Prophetic Example

Multiple player video games allow several players to assume different characters each having separate views of the game. In games where one character reacts to another character's actions it is necessary that each player sees their character's view and does not see other players views. Today, the display area is divided up into separate areas for each player allowing players to “sneak peeks” at other players view and ascertain information not available from their own view. Using the above described techniques a video game is able to display a different series of images for each player's character and any given player is restricted to viewing the series of images intended for their character.

### Multiple Shows Prophetic Example

In many households there arises the problem of what to watch on TV when two viewers want to watch a different show. If one has a TV having 3D capabilities the ability to watch different shows on a single TV is possible. Today 3D TV's using alternating sequencing have the ability to display multiple series of images using the techniques of the present invention. Multiple tuners are needed to watch shows on different channels. Other inputs can be used to provide a series of images and are listed earlier in this description. Each viewer selects or programs eyewear to restrict viewing to the desired show or other series of images.

### Multiple View Point Prophetic Example

Using the techniques of the present invention it is possible to create movies and shows the viewers can experience the show or movie from a specific character's eyes. A different series of images are displayed, one series of images for each character's perspective. Eyewear is then chosen by a viewer to restrict their viewing experience to one of the character's viewpoints.

### Display Security Prophetic Example

Confidential patient information displayed in a hospital should only be viewed by authorized personnel. Monitors having the 3D capabilities of the present invention may display two different series of images that interfere with each other such that when viewed without proper eyewear or from the proper position is seen as an readable image. One series of images could be the inverse of the second series of images so a screen would be seen as all one color without the appropriate eyewear. If active eyewear is used in this example both lenses of the eyewear are synchronized to the appropriate series of images and only then can an authorized person view the patient information.

Using wavelength shifted or interference filter technology pairs of narrowband wavelengths in the same color band may be used to display information on a monitor. When viewed by the unaided eye the display would be seen as a single color, but when viewed with eyewear having the same dichroic lens for both eyes only one wavelength would be seen thus revealing the information.

It is understood that the above-described embodiments and examples are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Additionally, although the figures illustrate particular presentations of information, it is understood that the varieties of such that satisfy the limitations of the claims are plethoric.

It is also envisioned that embodiments of the invention may incorporate technologies not yet in existence and may operate in manners not yet contemplated.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as series forth in the claims. Further, it is contemplated that an embodiment may be limited to consist of or to consist essentially of one or more of the features, functions, structures, methods described herein.

What is claimed is:

1. A method restricting unauthorized persons from viewing confidential information, the method comprising the steps of:
a. providing images from an image source module;
b. processing the images from the image source module to create multiple series of images that interfere with each other;
c. displaying the multiple series of images that interfere with each other resulting in an unreadable series of image on a display module; and,
d. enabling an authorized viewer to view a readable series of images from the unreadable series of images displayed by the display module.

2. The method of claim 1, wherein the step of displaying is implemented using eyewear image separation to display multiple series of images, and the step of restricting a viewer to a single series of images from the multiple series of images is implemented by the viewer wearing eyewear.

3. The method of claim 2, wherein eyewear image separation comprises a technique selected from the group of techniques consisting of:
a. alternate sequence;
b. polarization;
c. wavelength shifting; and
d. anaglyphic separation.

4. A tangible computer readable medium including computer readable instructions for performing the steps of:
a. providing a series of images from an image source module;
b. processing the images from the source module to create multiple series of images that interfere with each other;
c. displaying the multiple series of images that interfere with each other resulting in an unreadable series of image on a display module; and,
d. enabling an authorized viewer to view a readable series of images from the unreadable series of images displayed by the display module.

5. A filter means that filters light according to a display characteristic, wherein light filtering applies substantially equally to both eyes of a viewer.

6. The filter means of claim 5, wherein the filter means includes a filter toggle that alters the filtering effect.

7. The filter means of claim 5, wherein the filter means includes a machine readable code associated with a set of filter characteristics.

8. The filter means of claim 5, wherein the filter means includes a human readable indicia associated with a set of filter characteristics.
